(19) United States
(12) Patent Application Publication
(10) Pub. No.: US 2010/0330221 A1
(43) Pub. Date: Dec. 30, 2010

(54) IMPRINT STAMPER AND IMPRINT DEVICE

(75) Inventor: Shinji UCHIDA, Nagano (JP)

Correspondence Address: ROSSI, KIMMS & McDOWELL LLP., 20609 Gordon Park Square, Suite 150, Ashburn, VA, 20147, US

(73) Assignee: FUJI ELECTRIC DEVICE TECHNOLOGY CO. LTD., Tokyo (JP)

(21) Appl. No.: 12/719,884

(22) Filed: Mar. 9, 2010

(30) Foreign Application Priority Data
Jun. 26, 2009 (JP) 2009-152471

(51) Int. Cl. B28B 11/08

(52) U.S. Cl. 425/385

(57) ABSTRACT

An imprint stamper and imprint device are provided which, at the same time as being able to swiftly separate a substrate from a stamper after imprinting utilizing an even bowing and the resilience of the stamper when imprinting, can respond to a switch to mass production by making it difficult for a defect to occur on the pattern surface of the substrate and stamper. A stamper is configured of a plate-shaped body whose Young's modulus is 50 GPa or more, 500 GPa or less, whose thickness is 200 μm or more, 1000 μm or less, and which has a bow with a curvature of 2×10⁻⁵ or more, 2×10⁻³ or less, wherein a microstructure pattern to be transferred is provided on one surface.

### BACKGROUND

The present invention relates to an imprint stamper for transferring a microstructure pattern to a substrate, and to an imprint device in which it is used.

In recent years, an increase in the recording capacity of an information recording device has been accomplished by a miniaturization of a recording cell of a magnetic recording medium. Accompanying this, there is a demand in the recording cell manufacturing process for microfabrication techniques at a level of approximately 100 nm or less. These microfabrication techniques include electron beam lithography, focused ion beam lithography, nanoimprint lithography (hereafter, NIL), and the like.

Among these, with the NIL technique, which is a technique (for example, refer to U.S. Pat. No. 5,772,905) wherein a stamper, on which a concave-convex pattern is formed in advance with electron beam lithography, or the like, as a desired microstructure pattern to be transferred, is pressed against the resist surface of a substrate, and a pattern transfer is carried out, it is possible to transfer a pattern onto the whole surface of a magnetic recording medium with one process, meaning that a high throughput can be realized.

There being a UV imprint method, a hot embossing method, a high pressing force pressing method, and the like, as NIL technique imprint methods, a large number of proposals have been made relating to the configuration of the stamper and substrate, and the material or thickness of the resist used in the transfer, in order that a micropattern can be evenly transferred when applying a pressing force (for example, refer to JP-A-2005-108351), but during the imprint, the stamper and transfer receiving substrate come into contact, and a large adherence force (a force which occurs due to a vacuum contact, the viscosity of the resist and die release agent, and the like) is generated between the stamper and substrate after the imprint. For this reason, a detaching device which fixes the stamper or substrate and pulls the stamper away from the substrate, and the process itself, are necessary.

For example, in JP-A-9-219041, a horizontal base which holds the stamper by adsorption, and a detaching plate which holds by adsorption a substrate on which a light curing resin is coated, are included. Also, there is included a center pin which is attached to a central portion of the horizontal base so as to be vertically movable toward the detaching plate, and which, when moved upward, engages with a rim portion of a central hole in the substrate, and detaches the substrate from the stamper on the horizontal base.

With this device, by moving the center pin upward while suctioning the substrate to the detaching plate side by extracting the air between the detaching plate and substrate, the vicinity of the rim portion of the central hole in the substrate is pushed up toward the detaching plate. At this time, the central portion of the substrate is detached from the stamper.

As another method, a device has been proposed in WO/2004/100142 which, including a suctioning unit and squeezing mechanism configured in such a way that, by suctioning one predetermined portion of a surface other than the pattern surface of the stamper, the one portion can be detached from a resist layer, is configured in such a way that the range in which the detachment of the stamper is completed can be gradually enlarged from the condition in which the one portion of the stamper is detached by the suctioning unit.

Also, a nanoimprint stamper characterized by the stamper having a detaching mechanism is proposed in JP-A-2004-288845. It is described that with this method, by the concave-convex formation surface side of the stamper having a curvature, the process of detaching the stamper from the substrate is carried out with high precision and easily.

However, with the method of JP-A-9-219041, as a force for pushing the substrate up is necessary in order to detach the stamper from the substrate, it is found that, at the same time as damaging the vicinity of the rim portion of the substrate, particles are emitted, dirtying the inside of the device.

In the event that particles emitted by the device and particles emitted when the stamper is detached from the substrate adhere to the micropattern formed on the stamper, the particles cause a pattern defect when imprinting. That is, with this method, the kind of mass production wherein imprints are repeatedly carried out at a high speed is not possible.

Also, with this configuration, as a pressing mechanism which presses the substrate against the stamper, carrying out a concave-convex pattern formation, and the detaching mechanism, are separate, there is a problem in that there are a large number of process steps, and processing time is long. Furthermore, there being a large number of mechanism portions, there is a problem in that there is a drop in yield due to the emission of particles from the device mechanism portions, and the price of the device increases. The same also applies to the configuration of WO/2004/100142.

Then, the method of JP-A-2004-288845 being one which promotes the die detachment utilizing the resilience of the substrate, the force needed to cause the substrate to bow, and the resilience of the substrate, differ due to differences in the thickness and elasticity of the substrate, and it is not possible to imprint uniformly.

In particular, when using a strengthened glass substrate with a thickness of from 0.5 to 0.8 mm, like a magnetic recording medium, it is not possible to cause the substrate to bow with the pressing force necessary for the imprint. In the event of using a polymer substrate, the resilience of the substrate is low, and insufficient for promoting die detachment.

Also, with regard to the shape of the substrate, although the method works with a disc substrate, in the event that the substrate is rectangular, or with the kind of substrate in which a hole is opened in the inner circumference, it is not possible to cause the substrate to bow evenly, and an uneven pressure when applying a pressing force, and by extension an inconsistency in remaining film thickness, occur. Furthermore, with this method, as the detachment is promoted by the substrate side bowing in one direction, it is not possible to imprint both sides simultaneously.

### SUMMARY OF THE INVENTION

The invention, bearing in mind the heretofore described facts, provides an imprint stamper and imprint device which, at the same time as being able to swiftly separate a substrate from a stamper after imprinting utilizing an even bowing and the resilience of the stamper when imprinting, can respond to a switch to mass production by making it difficult for a defect to occur on the pattern surface of the substrate and stamper.

An imprint stamper of the invention is preferably configured of a plate-shaped body whose Young's modulus is 50 GPa or more, 500 GPa or less, whose thickness is 200 μm or more, 1000 μm or less, and which has a bow with a curvature of 2×10⁻⁵ or more, 2×10⁻³ or less, wherein a microstructure pattern to be transferred is provided on one surface thereof.

Also, an imprint device of the invention includes a pressing unit which, with the imprint stamper of the invention and a transfer receiving substrate in a condition in which they are superimposed one on the other, corrects the bow of the stamper, and applies a pressing force in order to transfer a microstructure pattern.

Herein, it is preferable that the pressing unit includes an upper die and a lower die which sandwich and press the stamper and transfer receiving substrate in the condition in which they are superimposed one on the other. Also, it is preferable when transferring with a magnetic disc as the transfer receiving substrate that a hole is opened in the center of the stamper and transfer receiving substrate, a positioning center pin which passes through the holes is provided, and a holding jig which holds the stamper outside a pattern area of the stamper is provided.

In the invention, a transfer receiving surface of the transfer receiving substrate, preferably having a resist layer formed thereon, is flat, and a microstructure pattern surface provided on one surface of the stamper is pressed against the transfer receiving surface, and transferred thereto.

At this time, by pressing on the other surface of the stamper with the flat surface of the pressing unit, as well as the bow of the stamper pressed between the pressing unit and the flat transfer receiving surface of the transfer receiving substrate being corrected, the microstructure pattern of the stamper is transferred to the transfer receiving surface of the transfer receiving substrate.

Subsequently, as the pressing with the pressing unit being released, the bow is restored to its original state by the elasticity of the stamper, and the stamper attains a condition in which it is detached from the flat transfer receiving surface of the transfer receiving substrate due to the bow. Herein, “flat” means a flat condition when seen macroscopically, it includes a condition in which there is a bow, an undulation, or an irregularity (the microstructure) of an extent which can be ignored due to the connection with the bow of the stamper.

According to the invention, as a stamper and substrate for an imprint brought into close contact by pressing with a pressing unit are swiftly separated by a release operation of the pressing unit, there is no need for a detaching process which forcibly pulls them apart.

For this reason, it does not happen that there is a worsening of yield due to the emission of particles and, as well as it being possible to realize a low-priced device, it is possible to respond to a switch to mass production.

### BRIEF DESCRIPTION OF THE DRAWINGS

The invention will be described with reference to certain preferred embodiments thereof and the accompanying drawings, wherein:

FIG. 1 is a sectional schematic diagram showing an embodiment of a stamper of the invention together with a transfer receiving substrate;

FIG. 2 is a sectional schematic diagram showing another embodiment of the stamper of the invention together with the transfer receiving substrate;

FIGS. 3A to 3C are operational illustrations showing an embodiment of an imprint device of the invention with sectional schematic diagrams; and

FIG. 4 is a sectional schematic diagram showing another embodiment (a two-sided transfer) of the imprint device of the invention.

### DETAILED DESCRIPTION OF THE PREFERRED EMBODIMENTS

Hereafter, a description will be given, referring to the drawings, of embodiments of the invention. The same reference numerals and characters are given to components common throughout the embodiments, and a redundant description is omitted. The invention is not limited by the embodiments.

Embodiments of Stamper

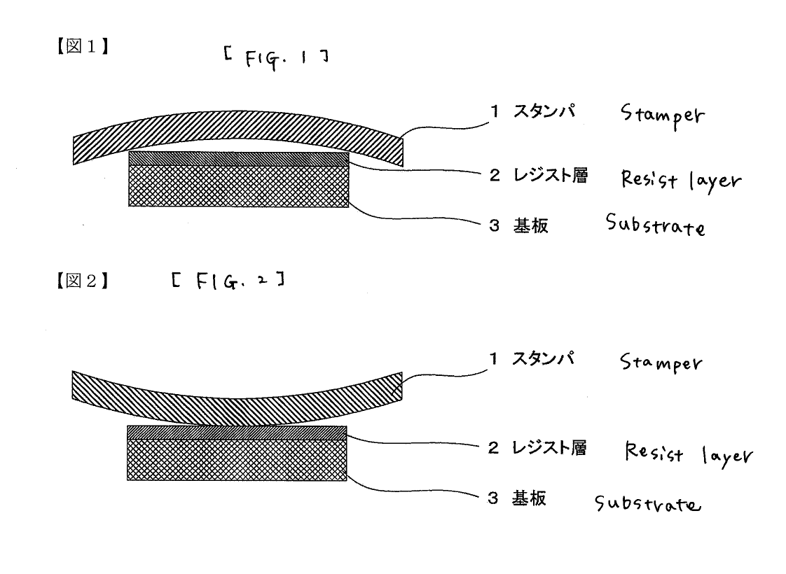

A description will be given, using FIGS. 1 and 2, of embodiments of a stamper of the invention.

FIG. 1 is a diagram showing relative positions of a transfer receiving substrate and a stamper of an embodiment of the invention. In FIG. 1, a resist surface acting as a transfer receiving surface of a substrate 3 on which a resist layer 2 is formed is disposed on a stamper 1 side, and a pattern is formed by pressing the resist surface against the stamper 1. Although not shown, in the stamper 1 of FIG. 1, there being a microstructure pattern to be transferred on a surface in contact with the resist layer 2 on the substrate 3 (the lower surface of the stamper 1 in FIG. 1), a pattern surface of the stamper 1 is pressed against the resist surface of the substrate 3. The stamper 1 of the embodiment has a concave lens type of concave bow with respect to the substrate 3.

FIG. 2 is a diagram showing relative positions of the transfer receiving substrate and a stamper of another embodiment of the invention. In FIG. 2, in the same way as in FIG. 1, there being a microstructure pattern to be transferred on a surface in contact with the resist layer 2 on the substrate 3 (the lower surface of the stamper 1 in FIG. 2), a pattern surface of the stamper 1 is pressed against the resist surface of the substrate 3. The stamper 1 of the embodiment has a convex lens type of convex bow with respect to the substrate 3.

Also, it is also possible to obtain the same result with, as a stamper of still another embodiment, a stamper which is a combination of FIGS. 1 and 2, having a so-called horse saddle type of bow wherein, reading it like a clock from the center, twelve o'clock and six o'clock directions are concave, while three o'clock and nine o'clock directions are convex.

Then, the stampers of the heretofore described embodiments are configured of a plate-shaped body whose Young's modulus is 50 GPa or more, 500 GPa or less, whose thickness is 200 μm or more, 1000 μm or less, and which has a bow curvature of 2×10⁻⁵ or more, 2×10⁻³ or less, and a microstructure pattern to be transferred is provided on one surface thereof.

This kind of stamper can be manufactured by applying a bow to a heretofore known stamper manufactured by electroforming nickel or a nickel alloy on a master that has a microstructure pattern, or the like.

As a method of applying a bow to the stamper, in the event that the material of the stamper is nickel or a nickel alloy, there is a method whereby the opposite surface of the pattern (the rear surface) is mechanically abraded. For example, a surface protection film is formed on the pattern side using Trylaner International made Silitect-II. Next, the stamper is placed on a platen with the pattern side facing downward, and the rear surface side is randomly ground while being pressed with, for example, 1500 grit sandpaper. The amount of bow is controlled by the roughness of the sandpaper, pressing power, and time.

Also, in the event too that the material of the stamper is glass, or the like, in the same way, the pattern side is protected, and the rear surface side is randomly ground while being pressed with, for example, 1500 grit sandpaper. The amount of bow is controlled by the roughness of the sandpaper, pressing power, and time.

The substrate 3 on which the resist layer 2 is formed may be a transfer receiving substrate used in a heretofore known imprint method for a magnetic disc, or the like.

Embodiments of Imprint Device

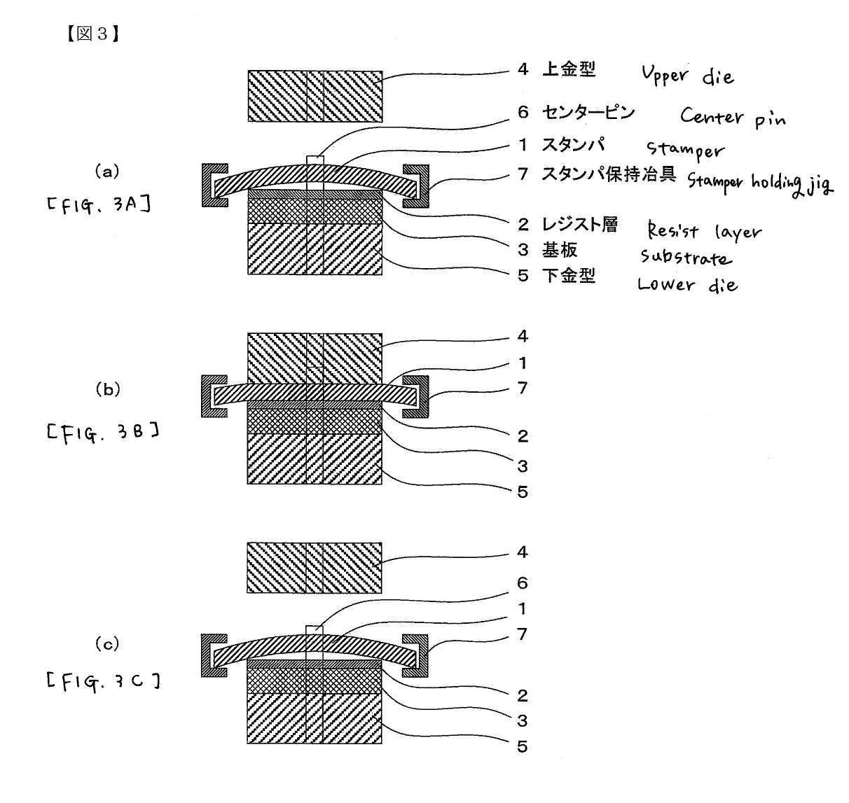

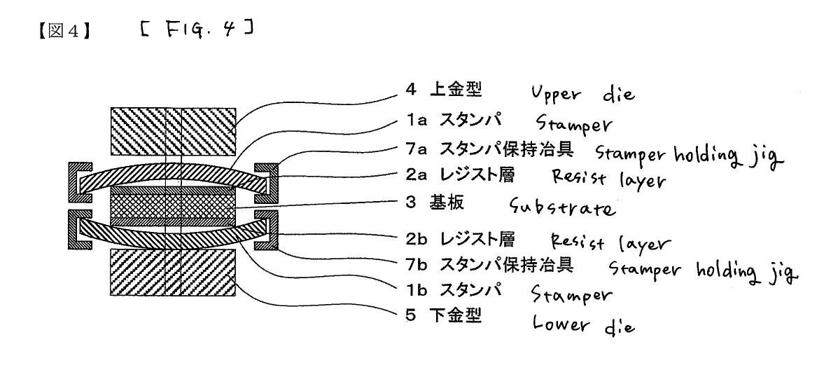

FIGS. 3A to 3C are illustrations of an operation of an embodiment of an imprint device of the invention.

Firstly, as shown in FIG. 3A, the disc-shaped substrate 3 whose transfer receiving surface is flat, which has a central hole, and on which the resist layer 2 is coated, and the disc-shaped stamper 1, which also has a central hole, and which has an outer diameter larger than that of the substrate 3, are set in a die set with a cylindrical upper die 4 and lower die 5 with flat pressing surfaces, which vertically oppose each other, a center pin 6 and a stamper holding jig 7, by impaling them on the center pin 6 for positioning and alignment.

Next, as shown in FIG. 3B, the substrate 3, on which the resist layer 2 is coated, and the stamper 1 are pressed into close contact by pressing with the upper and lower dies 4 and 5 which have the flat pressing surfaces. By this means, as well as the bow of the stamper 1 being corrected, the microstructure pattern of the stamper 1 is transferred to the resist layer 2 on the substrate 3.

Next, as shown in FIG. 3C, the pressing force is released, and the upper and lower dies 4 and 5 are opened. At this time, the bow is restored to its original state by the elasticity of the stamper 1, the stamper 1 attains a condition in which it is detached from the substrate 3 due to the bow and, even when holding a peripheral edge portion of the stamper 1, which is outside the pattern area, and lifting up the stamper 1 with the stamper holding jig 7, it does not happen that the substrate 3 comes with it.

FIG. 4 showing another embodiment of the imprint device of the invention, in the embodiment, as shown in FIG. 4, by forming resist layers 2a and 2b one on either side of the substrate 3, disposing stampers 1a and 1b above and below it, and carrying out an imprinting, a double-sided imprint is possible.

Working Example

Hereafter, a description will be given of a working example of the invention, wherein the heretofore described embodiments are further objectified. Although a description will be given of a working example which has a hard disc magnetic recording medium as a transfer receiving substrate, the invention is not limited to this.

In the working example, a glass 2.5 inch hard disc magnetic recording medium with an outer diameter of 65 mm, an inner diameter of 20 mm, and a thickness of 0.635 mm, and which has a magnetic recording layer on its surface, is used as the substrate 3.

A resist (Tokyo Ohka Kogyo Co., Ltd.'s OCNL505) for a room temperature imprint is applied by spin coating to a thickness of 100 nm on the substrate 3, and used as the resist layer 2. Nickel stampers 1 with an outer diameter of 95 mm, an inner diameter of 20 mm, having various kinds of thickness and bow shown in Table 1, and with a Young's modulus of 175 GPa, are prepared. A pattern is formed on the stampers 1 within a range from an inner diameter of 25 mm to an outer diameter of 60 mm, with a groove width of 67 nm, a land width of 33 nm, and a pattern height of 50 nm for a track pitch of 100 nm in the circumferential direction.

As shown in FIG. 3A, the substrate 3 on which the resist layer 2 is coated, and the stamper 1, are set in the die set with the vertically opposed cylindrical upper die 4 and lower die 5, the center pin 6 and stamper holding jig 7, by impaling them on the center pin 6.

Next, as shown in FIG. 3B, the substrate 3, on which the resist layer 2 is coated, and the stamper 1 are pressed into close contact by pressing the upper and lower dies 4 and 5 at 300 kN.

Next, as shown in FIG. 3C, the pressing force is released, and the upper and lower dies 4 and 5 are opened. At this time, provided that it has a predetermined bow, the stamper 1 attains a condition in which it is detached from the substrate 3, as shown in FIG. 3C, and even when lifting up the stamper 1 with the stamper holding jig 7, it does not happen that the substrate 3 comes with it.

However, at this time, in the event that the original bow of the stamper is small, the stamper does not become detached from the substrate and, when the stamper is lifted up by the stamper holding jig 7, the substrate comes with the stamper.

Also, the formation condition of the pattern formed on the resist layer 2 is confirmed with a scanning electron microscope (SEM) and atomic force microscope (AFM). As a result, with the stamper 1 which has a bow within the predetermined range, no pattern defect is detected with the SEM observation, and the pattern height is 30 nm or more from the inner circumference to the outer circumference.

As opposed to this, in the event that the original bow of the stamper is large, a portion in which the pattern is narrow is seen in the vicinity of the outer circumference with the SEM observation, and with the AFM, it is seen that the pattern height in that portion is less than 30 nm. In this portion, the pattern line width in the post-processing pattern is small, and it is not possible to obtain a good signal characteristic as a pattern medium.

The thickness and bow of the stampers, and results of the substrate and stamper detachment condition, and pattern formation condition, when the dies are opened, are shown in Table 1. In Table 1, Condition *1 is a case in which the substrate does not come with the stamper even when the stamper is lifted up by the stamper holding jig after the dies are opened is indicated by 0, and a case in which it does is indicated by X; and Condition *2 is a case in which a portion in which the pattern is narrow is seen in the vicinity of the outer circumference with the SEM observation, and it is seen with the AFM that the pattern height in that portion is less than 30 nm, is indicated by X.

TABLE 1

| | | Stamper Bow | Stamper | |
|---|---|---|---|---|
| Stamper | Stamper Bow | Amount | Detachment | Pattern Formation |
| Thickness | Shape | (Curvature) | Condition *1 | Condition *2 |
| 150 μm | Concave | 2 × 10⁻⁴ | X | ◯ |
| 200 μm | Concave | 2 × 10⁻⁴ | ◯ | ◯ |
| 300 μm | Concave | 5 × 10⁻⁶ | X | ◯ |
| 300 μm | Concave | 1 × 10⁻⁵ | X | ◯ |
| 300 μm | Concave | 2 × 10⁻⁵ | ◯ | ◯ |
| 300 μm | Concave | 2 × 10⁻⁴ | ◯ | ◯ |
| 300 μm | Concave | 2 × 10⁻³ | ◯ | ◯ |
| 300 μm | Concave | 5 × 10⁻³ | ◯ | X |
| 300 μm | Concave | 1 × 10⁻² | ◯ | X |
| 300 μm | Convex | 2 × 10⁻⁴ | ◯ | ◯ |
| 300 μm | Horse saddle | 2 × 10⁻⁴ | ◯ | ◯ |
| 1000 μm | Concave | 2 × 10⁻⁴ | ◯ | ◯ |
| 1200 μm | Concave | 2 × 10⁻⁴ | ◯ | X |

As shown in table 1, it is found that, in the case of a nickel stamper whose Young's modulus is 175 GPa, when the substrate and stamper can be detached, and the pattern formation is good, the stamper thickness is 200 μm or more, 1000 μm or less, and the bow curvature is 2×10⁻⁵ or more, 2×10⁻³ or less.

Also, results when using materials with differing Young's modulus, on which the same pattern is formed, as the stamper are shown in Table 2. The thicknesses of the stampers are all taken to be 300 μm, and the bows the concave type.

In Table 2, Condition *1 is a case in which the substrate does not come with the stamper even when the stamper is lifted up by the stamper holding jig after the dies are opened is indicated by O, and a case in which it does is indicated by X; and Condition *2 is a case in which a portion in which the pattern is narrow is seen in the vicinity of the outer circumference with the SEM observation, and it is seen with the AFM that the pattern height in that portion is less than 30 nm, is indicated by X.

TABLE 2

| | Stamper | | Stamper Bow | Stamper | |
|---|---|---|---|---|---|
| | Young's | | Amount | Detachment | Pattern Formation |
| Stamper Material | Modulus | | (Curvature) | Condition *1 | Condition *2 |
| Polycarbonate | 2.5 | GPa | 2 × 10⁻⁴ | X | X Pattern destroyed |
| | | | | | when detaching |
| Aluminum alloy | 55 | GPa | 2 × 10⁻⁴ | ◯ | ◯ |
| Glass | 90 | GPa | 2 × 10⁻⁴ | ◯ | ◯ |
| Si<100> | 130 | GPa | 2 × 10⁻⁴ | ◯ | ◯ |
| Si<111> | 180 | GPa | 2 × 10⁻⁴ | ◯ | ◯ |
| SiC | 450 | GPa | 2 × 10⁻⁴ | ◯ | ◯ |
| SiC (diamond-like | 510 | GPa | 2 × 10⁻⁴ | ◯ | X Pattern abnormality |
| carbon film) | | | | | in vicinity of outer |
| | | | | | circumference |

As shown in Table 2, when using a stamper whose Young's modulus is 50 GPa or less, the resilience of the stamper after the application of the imprint pressing force weakens, and a good detachment is not possible. Also, in the case of a stamper whose Young's modulus is 500 GPa or more, a portion in which the pattern is narrow is seen in the pattern in the vicinity of the outer circumference, and it is seen with the AFM that the pattern height in that portion is less than 30 nm. It is thought that this is because, due to the Young's modulus of the stamper being too large, the pressing force in the vicinity of the outer circumference of the stamper is weak when the imprint pressing force is applied.

As heretofore described, it is found that the substrate and stamper can be detached with a stamper whose Young's modulus is 50 GPa or more, and that the pattern formation is good with a stamper whose Young's modulus is 500 GPa or less.

### INDUSTRIAL APPLICABILITY

The imprint stamper and imprint device of the invention can be utilized in the formation of a microstructure pattern for the manufacture of a magnetic recording medium such as a discrete track medium or bit patterned medium, semiconductor device, or the like.

The invention has been described with reference to certain preferred embodiments thereof. It will be understood, however, that modifications and variations are possible within the scope of the appended claims.

This application is based on, and claims priority to, Japanese Patent Application No: 2009-152471, filed on Jun. 26, 2009. The disclosure of the priority application, in its entirety, including the drawings, claims, and the specification thereof, is incorporated herein by reference.

What is claimed is:

1. An imprint stamper comprising:
a plate-shaped body whose Young's modulus is 50 GPa or more, 500 GPa or less, whose thickness is 200 μm or more, 1000 μm or less, and which has a bow with a curvature of 2×10⁻⁵ or more, 2×10⁻³ or less; and
a microstructure pattern provided on one surface of the plate-shaped body.

2. An imprint device comprising:
a pressing unit adapted to receive an imprint stamper and a transfer receiving substrate in a condition in which th imprint stamper and the transfer receiving substrate are superimposed one on the other;
wherein the imprint stamper includes a plate-shaped body whose Young's modulus is 50 GPa or more, 500 GPa or less, whose thickness is 200 μm or more, 1000 μm or less, and which has a bow with a curvature of 2×10⁻⁵ or more, 2×10⁻³ or less, and a microstructure pattern provided on one surface of the plate-shaped body; and
wherein the pressing unit corrects the bow of the imprint stamper and applies a pressing force in order to transfer the microstructure pattern to the transfer receiving substrate.

3. The imprint device according to claim 2, wherein the pressing unit includes an upper die and a lower die which sandwich and press the imprint stamper and transfer receiving substrate in the condition in which they are superimposed one on the other.

4. The imprint device according to claim 2, wherein a hole is opened in the center of the imprint stamper and transfer receiving substrate, and the imprint device further includes a positioning center pin which passes through the holes in the imprint stamper and the transfer receiving substrate, and a holding jig which holds the imprint stamper outside a pattern area of the imprint stamper.
